(19) United States
(12) Patent Application Publication
(10) Pub. No.: US 2024/0378706 A1
(43) Pub. Date: Nov. 14, 2024

(54) JOINT PAN -SPECTRAL (JPAL) RESTORATION

(71) Applicant: Maxar Mission Solutions Inc., Westminster, CO (US)

(72) Inventors: Alexander G. Iacchetta, Grass Lake, MI (US); Richard G. Paxman, Saline, MI (US); Dustin Moore, Saline, MI (US); Thomas C. Zaugg, Spanish Fork, UT (US)

(21) Appl. No.: 18/316,016

(22) Filed: May 11, 2023

(51) Int. Cl. G06T 5/00

(52) U.S. Cl. CPC G06T 5/70; G06T 2207/10036

(57) ABSTRACT

Joint Pan-spectrAL (JPAL) restoration may be provided. Initial panchromatic imagery data and initial multi-spectral imagery data may be received. Then an estimation-theoretic technique and a physics-based model may be applied to the panchromatic imagery data and the multi-spectral imagery. Next, in repose to applying the estimation-theoretic technique and the physics-based model, de-aliased panchromatic imagery data and de-aliased multi-spectral imagery that is more finely sampled than the initial panchromatic imagery data and the initial multi-spectral imagery may be obtained.

### GOVERNMENT LICENSE RIGHTS

This invention was made with government support under Contract Number FA8750-20-C1520 awarded by the Air Force Research Laboratory (AFRL). The government has certain rights in the invention.

### TECHNICAL FIELD

The present disclosure relates generally to providing Joint Pan-Spectral (JPAL) restoration.

### BACKGROUND

Satellite images are images of Earth collected by imaging satellites operated by governments and businesses around the world. Satellite imaging companies sell images by licensing them to governments and businesses. Satellite images have many applications in meteorology, oceanography, fishing, agriculture, biodiversity conservation, forestry, landscape, geology, cartography, regional planning, and education. Images may be in visible colors and in other spectra. There are also elevation maps, usually made by radar images. Image interpretation and analysis of satellite imagery may be conducted using software.

Pan sharpening is a process of merging fine-resolution panchromatic and coarser-resolution multispectral imagery to create a single fine-resolution color image. Map creating enterprises may use this process to increase image quality. Pan sharpening produces a fine-resolution color image from three, four, or more coarse-resolution multispectral satellite bands plus a corresponding fine-resolution panchromatic band.

### BRIEF DESCRIPTION OF THE FIGURES

The accompanying drawings, which are incorporated in and constitute a part of this disclosure, illustrate various embodiments of the present disclosure. In the drawings:

FIG. 1 is a diagram of an operating environment for obtaining image data;

FIG. 2 is a flow chart of a method for providing Joint Pan-spectrAL (JPAL) restoration;

FIG. 3 illustrate applying a forward sensor model (i.e., physics-based model) to the simulated image;

FIG. 4 illustrate a clear-aperture function; and

FIG. 5 is a block diagram of a computing device.

### DETAILED DESCRIPTION

### Overview

Joint Pan-spectrAL (JPAL) restoration may be provided. Initial panchromatic imagery data and initial spectral data may be received. Then an estimation-theoretic technique and a physics-based model may be applied to the panchromatic image data and the multi-spectral imagery. Next, in repose to applying the estimation-theoretic technique and the physics-based model, de-aliased panchromatic imagery data and de-aliased multi-spectral imagery that is more finely sampled than the initial panchromatic imagery data and the initial multi-spectral imagery may be obtained.

Both the foregoing overview and the following example embodiments are examples and explanatory only, and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Pan sharpening is utilized by image analysts. Pan sharpening is an image fusion process in which fine-resolution panchromatic data are fused with coarse-resolution multispectral data to create a colorized fine-resolution image. The spatial resolution of this colorized product is the native resolution of the pan image. However, conventional processes do not provide fine-resolution spectral images for spectral exploitation.

Embodiments of the disclosure may use an estimation-theoretic approach to modelling data acquisition and performing image restoration. A physics-based forward-imaging model may be constructed that includes the effects of optical propagation, detection, and noise. An estimator may be provided by constructing the Probability Distribution Function (PDF) and incorporating a priori knowledge of the spatial-spectral object sparseness to obtain a robust estimate. A non-linear optimization search may be used to find the regularized maximum-likelihood estimate of the individual band images. An image sensor may be designed so that the fine-resolution pan image is under-sampled (i.e., aliased) relative to Nyquist sampling associated with diffraction. The forward model may capture this aliasing and the JPAL algorithm seeks to perform de-aliasing, allowing embodiments of the disclosure to restore to a finer spatial resolution than the original pan image.

Accordingly, embodiments of the disclosure may combine finely sampled panchromatic imagery with coarsely sampled multi-spectral imagery and may use estimation-theoretic techniques and physics-based modeling to produce de-aliased panchromatic and multi-spectral imagery that may be more finely sampled than the original panchromatic imagery. This process may improve upon conventional pan-sharpening by performing de-aliasing and maintaining spectral accuracy.

Conventional pan-sharpening processes do not retain spectral fidelity enough to produce spectral information that is useful for a spectral analyst at the desired spatial resolution. Embodiments of the disclosure may retain spectral fidelity while also producing a de-aliased product, which may also be unique to the disclosure. Registration may be performed as part of embodiments of the disclosure directly on unprocessed data and the registration may become part of the disclosed process, preserving the underlying physics behind the process. Furthermore, embodiments of the disclosure may handle sequential collections of the panchromatic and multi-spectral data, meaning that embodiments of the disclosure may be capable of dealing with disparity between the collected bands. Nonnegative matrix factorization may be used to instantiate the process and the factorization may be used as a basis set as part of the regularization process in addition to edge-preserving regularization. In addition to retaining spatial-spectral accuracy in the restored spectral data cube, embodiments of the disclosure may mitigate color bleeding in a Red Green Blue (RGB) product. The disclosed process may be generalized to work with hyperspectral sensors with context (panchromatic) imagers, with portions of the electromagnetic spectrum outside of the visible regime, and with other imaging modalities (e.g., spectral polarimeters) for example.

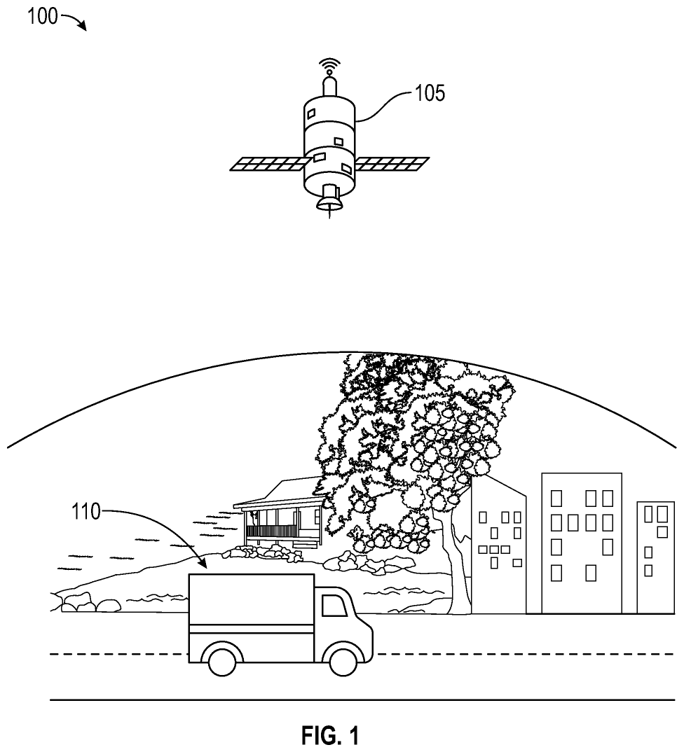

FIG. 1 shows an operating environment 100 for obtaining image data for Joint Pan-spectrAL (JPAL) restoration. As shown in FIG. 1, operating environment 100 may comprise a satellite 105 and an object 110. Satellite 105 may comprise a commercial Earth observation and imaging satellite used or designed for Earth Observation (EO) from orbit, including environmental monitoring, meteorology, cartography, and others. Satellite 105 may collect images in panchromatic and multispectral bands for example. The orbiting altitude of satellite 105 may comprise, but is not limited to, 617 km. Satellite 105 may be used to take images of object 110 that may be on the surface of the Earth. While FIG. 1 shows object 110 as a truck, object 110 may comprise anything and is not limited to a truck.

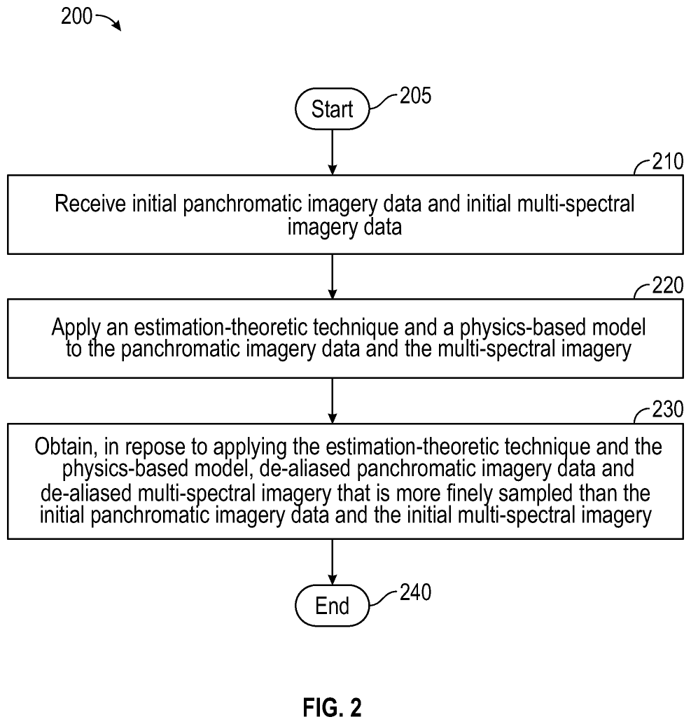

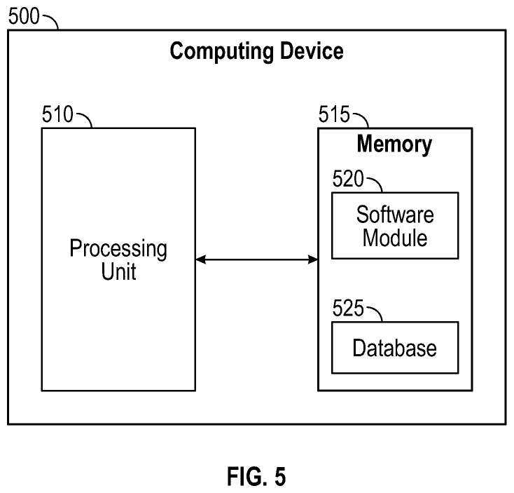

FIG. 2 is a flow chart setting forth the general stages involved in a method 200 consistent with embodiments of the disclosure for providing Joint Pan-spectrAL (JPAL) restoration. Method 200 may be implemented using a computing device 500 as described in more detail below with respect to FIG. 5. Ways to implement the stages of method 200 will be described in greater detail below.

Method 200 may begin at starting block 205 and proceed to stage 210 where computing device 500 may receive initial panchromatic imagery data and initial multi-spectral imagery data. The initial panchromatic imagery data may be more finely sampled than the initial multi-spectral imagery. For example, computing device 500 may receive the initial panchromatic imagery data and the initial multi-spectral imagery data obtained by satellite 105. The initial panchromatic imagery data and the initial multi-spectral imagery may be associated with a scene that may include object 110.

From stage 210, where computing device 500 receives the initial panchromatic imagery data and the initial multi-spectral imagery data, method 200 may advance to stage 220 where computing device 500 may apply an estimation-theoretic technique and a physics-based model to the panchromatic imagery data and the multi-spectral imagery. For example, applying the estimation-theoretic technique and the physics-based model may comprise creating an initial quasi-Hyperspectral (HS) set of images (i.e., data cube) and iteratively improving the initial quasi-HS data cube so that is it consistent with the initial data. The initial

Quasi-HS data cube may be constructed using the obtained initial panchromatic imagery data and the initial multi-spectral imagery data. As shown below, any intermediate quasi-HS data cube can be used in conjunction with the physics-based forward model to create corresponding estimates of the Pan and Multi-Spectral (MS) data.

$${l , d}_{} \to \begin{matrix}{\hat{P}}_{d} \\ {k , d}_{}\end{matrix}$$

[symbol] _{l,d}: guess forquasi-HS data cube with spectral sampling l and spatial sampling
\hat{P}d: guess for Pan image with and spatial sampling d
[symbol] _{k,d}: guess for MS images with spectral sampling k and spatial sampling d

Iteratively improving the quasi-HS data cube may comprise iteratively performing, until a predetermined condition is met: i) applying the physics-based model to the quasi-HS data cube to obtain an estimated panchromatic imagery data and an estimated multi-spectral imagery; and ii) using a Maximum-Likelihood Estimation (MLE) process to compare the initial panchromatic imagery data to the estimated panchromatic imagery data and to compare the initial multi-spectral imagery data to the estimated multi-spectral imagery data. The predetermined condition comprises, but is not limited to, a predetermined number of iterations (e.g., 25). In addition, the predetermined condition may comprise, but is not limited to, a predetermined error level in the MLE process. The MLE update process may comprise a variable-metric process (e.g., a Limited-memory Broyden Fletcher Goldfarb Shanno (L-BFGS) nonlinear optimization process).

In more detail, registration may be completed on the panchromatic imagery data and the multi-spectral imagery resulting in the quasi-HS data cube being initialized. Before initializing, a customized forward model (i.e., the physics-based model) for the sensor of satellite 105 based on sensor characteristics may be created from stored files that describe the optical system. The forward model may provide an Optical Transfer Function (OTF) of the system and a Relative Spectral Response (RSR) for every band to be processed. The OTF arrays may be sized to reduce wrap-around artifacts that may be induced by Fourier transform based convolutions.

One purpose of initialization may be to generate an initial estimate of the quasi-HS data cube for the optimization process and to set up the error metrics that may be reduced during optimization. The metrics may comprise two data-consistency metrics for the panchromatic imagery data and the multi-spectral imagery, and a third Bilateral Total Variation (BTV) metric that may serve as a regularization term to reduce the effects of noise. The process for creating an initial estimate may involve: i) transforming the multi-spectral imagery bands so that they are aligned with the panchromatic imagery band; ii) performing Gram-Schmidt pan-sharpening; iii) up-sampling to the model's spatial resolution; and iv) projecting the sensor bands to a hyperspectral data cube using the RSRs. Nonnegative Matrix Factorization (NMF) may be used to generate basis spectra and basis images from the quasi-HS data cube. During the optimization process, embodiments of the disclosure may only optimize over the basis images, which serves as a form of regularization. The BTV metric may act on each basis image independently.

Having created an initial estimate, the parameters used to create the simulated quasi-HS data cube may be progressively refined using a variable-metric process. The variable-metric process may iteratively solve constrained nonlinear optimization problems. In this case, the constraint may be nonnegativity. Each iteration may evaluate the current set of parameter values provided by the variable-metric process. With every iteration, a new simulated data set may be created using the forward model (i.e., physics-based model) and the current guess of the quasi-HS image basis components, and those simulated data sets may be compared to input data through the data-consistency metrics. Gradients of this process with respect to the quasi-HS data cube basis components, as well as those from the BTV regularization metric, may be used to refine the guess for the current quasi-HS data cube basis components. The below equation is an example of a regularized maximum-likelihood problem that may be iteratively solved using the variable-metric process. The process may be performed a predetermined number of times (e.g., 25 iterations) or it may stop when D₁ and D₂ are below predetermined values.

$${l , d}_{} ≡ {argmin}_{{l , d}_{}} \{ {{D}_{1} ( {P}_{\text{?}}}^{{\text{?}}^{\text{?}}} - {\hat{P}}_{\text{?}} ( {\text{?}}_{} ) ) + {D}_{2} ( {{MS}_{k , c}}^{{\text{?}}^{\text{?}}} - {k , c}_{} ( {\text{?}}_{} ) ) + {\sum }_{\text{?} = 1}^{N} {K}_{\text{?}} {R}_{\text{?}} ( {H}_{\text{?}} ( {\text{?}}_{} ) ) \}$$

$$\text{?} \text{indicates text missing or illegible when filed}$$

[symbol] indicate estimates
[symbol] (⋅): Data consistency function→normalized mean-square error
k: Scalar weights
[symbol] (⋅): Series of operations acting on optimization variables
[symbol] (⋅): Regularization function

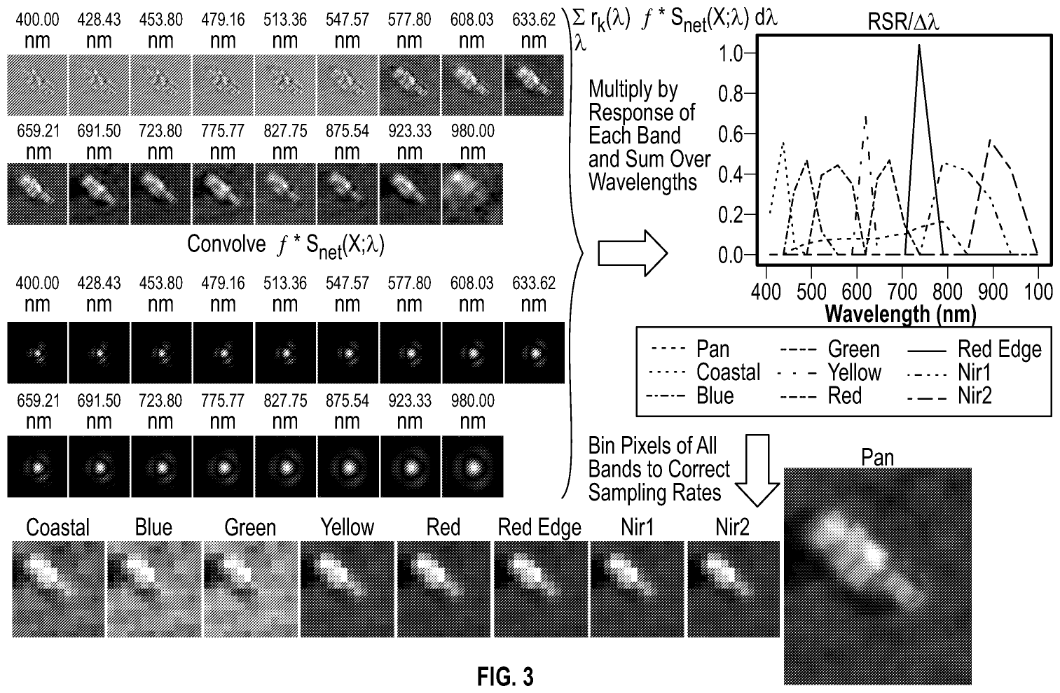

The first stage of the iteration loop may be the creation of the simulated imagery (i.e., quasi-HS data cube). Processing may comprise creating a new simulated data cube with the current parameters and multiple steps of applying the forward sensor model (i.e., physics-based model) to the simulated data cube. The basis images and stored basis spectra are used to generate the quasi-HS data cube. For collections in which the pan and bands are collected essentially simultaneously, the bands of the quasi-HS data cube may be transformed to be registered to the multi-spectral imagery bands prior to OTF convolution. For sequential collection, the multi-spectral imagery registration transformation may be combined with the detector simulation step at the end of the processing chain. OTF convolution may be performed using Fast Fourier Transforms (FFTs) and may be the most computationally burdensome aspect of the simulation process. The RSRs may then be used to convert from quasi-HS data cube to panchromatic and multi-spectral imagery bands. Pixel binning may be used to simulate the impact of the detector. At this point quasi-HS data cube estimates may be via the aforementioned L-BFGS-B equation. FIG. 3 illustrates an example of this process. As shown in FIG. 3, ƒ represents the quasi-HS data cube and sₙₑₜ represents the imaging point-spread function (PSF) derived from the physics-based model. The quasi-HS data cube is then converted to the format of the input image data by integrating the appropriate bands and binning pixels appropriately. We refer to this process as Simulated Image Creation. After these simulated images are compared to the input data images to find the error metric, the adjoint functions for Simulated Image Creation are applied to compute the error-metric gradients. Resulting gradients are used to update the quasi-HS data cube and the process iterates until stopping criteria are achieved.

Once computing device 500 applies the estimation-theoretic technique and the physics-based model to the panchromatic imagery data and the multi-spectral imagery in stage 220, method 200 may continue to stage 230 where computing device 500 may obtain, in repose to applying the estimation-theoretic technique and the physics-based model, de-aliased panchromatic imagery data and de-aliased multi-spectral imagery that is more finely sampled than the initial panchromatic imagery data and the initial multi-spectral imagery. Often the output MS imagery will have significantly finer spatial resolution that the original input MS data while retaining spectral fidelity. For example, the de-aliased panchromatic imagery data and de-aliased multi-spectral imagery may be obtained from the quasi-HS data cube after iteratively performing until the predetermined condition is met. Once computing device 500 obtains the de-aliased panchromatic imagery data and de-aliased multi-spectral imagery in stage 230, method 200 may then end at stage 240.

### Physics-Based Model

The forward model (i.e., physics-based model) of the imaging process includes a spectrally dependent Point-Spread Function (PSF), which determines the spatial-frequency response of each band, the spectral response of each detector, and the focal-plane sampling, which causes the aliasing. The sₙₑₜ PSF has multiple contributors, for example:

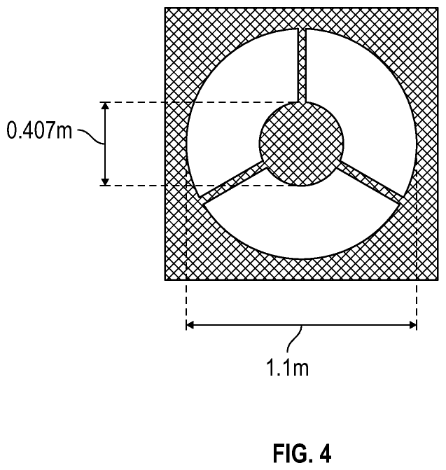

sₙₑₜ(x;λ)=s_{optical}*s_{detector}*s_{diffusion}*sₛₘₑₐᵣ*sⱼᵢₜₜₑᵣ*s_{adjacency}

where the components are ordered from the most to the least substantial contributor. The s_{optical} component is the incoherent PSF. To model s_{optical}, embodiments may use the clear-aperture function of the telescope in satellite 105, P(xₚ), as well as the wavefront aberration function, w(xₚ), where xₚ is a 2D spatial variable in the telescope pupil. The clear-aperture function is binary indicating the regions in which the light can be transmitted. An example clear-aperture function for the telescope is shown in FIG. 4. The wavefront-aberration function is defined over the telescope pupil and gives deviation from a perfect wavefront in terms of optical path. So long as the telescope does not have significant dispersive components, then the wavelength dependence on any incoherent PSF may be computed from the clear-aperture and wavefront-aberration functions alone.

The second most impactful component of the net PSF is s_{detector}. This PSF is due to the extent of the detector pixel. Satellite 105's detector array may, for example, have pixels that are 8 μm and 32 μm square for the panchromatic and multi-spectral imagery channels, respectively. Accordingly, s_{detector} may comprise a square 2D rectangular function with 8 μm or 32 μm on a side.

The third component is s_{diffusion}. This component is due to electron spill over in the Charge Couple Device (CCD) array. Embodiments of the disclosure may model this PSF component as a Gaussian with σ=1.5 μm for satellite 105. The fourth net PSF component is sₛₘₑₐᵣ, which derives from multi-phase charge transfer and from Loss of Signal (LOS) error within the control bandwidth (e.g., geometric smear). Embodiments of the disclosure may focus on the center of the Time Delay Integration (TDI) array, so that geometric smear is not an issue. This allows it to model the 4-phase TDI charge transfer associated with satellite 105 as a 1D rectangular function in the direction of charge transfer, with a width of 2 μm and 8 μm for the panchromatic and multi-spectral imagery arrays, respectively for example. Although these 1D smear contributions may seem small, they may not be trivial relative to the ultimate sampling rate that may be sought with restoration (4 μm).

The next component of the net PSF is sⱼᵢₜₜₑᵣ, which can be defined as LOS errors outside of the control bandwidth. For satellite 105, embodiments of the disclosure may use the Digital Globe model, which reduces the error to be small enough to be negligible. The final component of the net PSF is s_{adjacency}, which originates from blur induced by atmospheric scattering. This may be a small effect that is only observed with infrequent illumination and atmospheric conditions.

### Computations

FIG. 5 shows computing device 500. As shown in FIG. 5, computing device 500 may include a processing unit 510 and a memory unit 515. Memory unit 515 may include a software module 520 and a database 525. While executing on processing unit 510, software module 520 may perform, for example, processes for providing JPAL as described above with respect to FIG. 2. Computing device 500, for example, may be deployed in in satellite 105. Notwithstanding, computing device 500 may be deployed anywhere and the image data may be transmitted from satellite 105 to a network, for example, and then sent to computing device 500.

Computing device 500 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay devices, or other similar microcomputer-based device. Computing device 500 may comprise any computer operating environment, such as hand-held devices, multiprocessor systems, microprocessor-based or programmable sender electronic devices, minicomputers, mainframe computers, and the like. Computing device 500 may also be practiced in distributed computing environments where tasks are performed by remote processing devices. The aforementioned systems and devices are examples and computing device 500 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general-purpose computer or in any other circuits or systems.

Embodiments of the disclosure may be practiced via a system-on-a-chip (SOC) where each or many of the elements illustrated in FIG. 5 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 500 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
receiving initial panchromatic imagery data and initial multi-spectral imagery data;
applying an estimation-theoretic technique and a physics-based model to the initial panchromatic imagery data and the initial multi-spectral imagery data; and
obtaining, in repose to applying the estimation-theoretic technique and the physics-based model, de-aliased panchromatic imagery data and de-aliased multi-spectral imagery that is more finely sampled than the initial panchromatic imagery data and the initial multi-spectral imagery data.

2. The method of claim 1, wherein applying the estimation-theoretic technique and the physics-based model comprises:
creating a quasi-Hyperspectral (HS) data cube; and
iteratively improving the quasi-HS data cube wherein iteratively improving the quasi-HS data cube comprises iteratively performing, until a predetermined condition is met:
applying the physics-based model to the quasi-HS data cube to obtain an estimated panchromatic imagery data and an estimated multi-spectral imagery data; and
using a Maximum-Likelihood Estimation (MLE) process to compare the initial panchromatic imagery data to the estimated panchromatic imagery data and to compare the initial multi-spectral imagery data to the estimated multi-spectral imagery data.

3. The method of claim 2, further comprising improving the quasi-HS data cube based on data from the MLE process.

4. The method of claim 2, further comprising obtaining an estimated de-aliased panchromatic imagery data and estimated de-aliased multi-spectral imagery from the quasi-HS data cube after iteratively performing until the predetermined condition is met.

5. The method of claim 2, wherein using the MLE process comprise using the MLE process comprising a variable-metric optimization process.

6. The method of claim 2, wherein the predetermined condition comprises a predetermined number of iterations.

7. The method of claim 2, wherein the predetermined condition comprises a predetermined error level in the MLE process.

8. The method of claim 1, wherein the initial panchromatic imagery data is more finely sampled than the initial multi-spectral imagery data.

9. A system comprising:
a memory storage; and
a processing unit coupled to the memory storage, wherein the processing unit is operative to:
receive initial panchromatic imagery data and initial multi-spectral imagery data;
apply an estimation-theoretic technique and a physics-based model to the initial panchromatic imagery data and the initial multi-spectral imagery data; and
obtain, in repose to applying the estimation-theoretic technique and the physics-based model, de-aliased panchromatic imagery data and de-aliased multi-spectral imagery that is more finely sampled than the initial panchromatic imagery data and the initial multi-spectral imagery data.

10. The system of claim 9, wherein the processing unit being operative to apply the estimation-theoretic technique and the physics-based model comprises the processing unit being operative to:
create a quasi-Hyperspectral (HS) data cube; and
iteratively improve the quasi-HS data cube wherein the processing unit being operative to iteratively improve the quasi-HS data cube comprises the processing unit being operative to iteratively perform, until a predetermined condition is met:
applying the physics-based model to the quasi-HS data cube to obtain an estimated panchromatic image data and estimated multi-spectral imagery data; and
use a Maximum-Likelihood Estimation (MLE) process to compare the initial panchromatic imagery data to the estimated panchromatic imagery data and to compare the initial multi-spectral imagery data to the estimated multi-spectral imagery data.

11. The system of claim 10, wherein the processing unit is further operative to improve the quasi-HS data cube based on data from the MLE process.

12. The system of claim 10, wherein the processing unit is further operative to obtain the de-aliased panchromatic imagery data and de-aliased multi-spectral imagery from the quasi-HS data cube after iteratively performing until the predetermined condition is met.

13. The system of claim 10, wherein the processing unit being operative to use the MLE process comprise the processing unit being operative to use the MLE process comprising a variable-metric process.

14. The system of claim 10, wherein the predetermined condition comprises a predetermined number of iterations.

15. The system of claim 10, wherein the predetermined condition comprises a predetermined error level in the MLE process.

16. The system of claim 9, wherein the initial panchromatic imagery data is more finely sampled than the initial multi-spectral imagery data.

17. A non-transitory computer-readable medium that stores a set of instructions which when executed perform a method executed by the set of instructions comprising:
receiving initial panchromatic imagery data and initial multi-spectral imagery data;
applying an estimation-theoretic technique and a physics-based model to the initial panchromatic imagery data and the initial multi-spectral imagery data; and
obtaining, in repose to applying the estimation-theoretic technique and the physics-based model, de-aliased panchromatic imagery data and de-aliased multi-spectral imagery that is more finely sampled than the initial panchromatic imagery data and the initial multi-spectral imagery data.

18. The non-transitory computer-readable medium of claim 17, wherein applying the estimation-theoretic technique and the physics-based model comprises:
creating a quasi-Hyperspectral (HS) data cube; and
iteratively improving the quasi-HS data cube wherein iteratively improving the quasi-HS data cube comprises iteratively performing, until a predetermined condition is met:
applying the physics-based model to the quasi-HS data cube to obtain an estimated panchromatic image data and an estimated multi-spectral imagery data; and
using a Maximum-Likelihood Estimation (MLE) process to compare the initial panchromatic imagery data to the estimated panchromatic imagery data and to compare the initial multi-spectral imagery data to the estimated multi-spectral imagery data.

19. The non-transitory computer-readable medium of claim 18, further comprising improving the physics-based model based on data from the MLE process.

20. The non-transitory computer-readable medium of claim 18, further comprising obtaining the de-aliased panchromatic imagery data and de-aliased multi-spectral imagery from the quasi-HS data cube after iteratively performing until the predetermined condition is met.
